(19) United States
(12) Patent Application Publication
(10) Pub. No.: US 2026/0018345 A1
(43) Pub. Date: Jan. 15, 2026

(54) MULTILAYER CERAMIC ELECTRONIC COMPONENT AND METHOD OF MANUFACTURING THE SAME

(71) Applicant: TAIYO YUDEN CO., LTD., Tokyo (JP)

(72) Inventors: Yoichi KATO, Tokyo (JP); Tomoyasu EGUCHI, Tokyo (JP); Takashi ASAI, Tokyo (JP)

(73) Assignee: TAIYO YUDEN CO., LTD., Tokyo (JP)

(21) Appl. No.: 19/335,685

(22) Filed: Sep. 22, 2025

Related U.S. Application Data
(63) Continuation of application No. PCT/JP2024/013291, filed on Mar. 29, 2024.

(30) Foreign Application Priority Data
Mar. 31, 2023 (JP) 2023-058915

(51) Int. Cl. H01G 4/30; H01G 4/012

(52) U.S. Cl. CPC H01G 4/30; H01G 4/012

(57) ABSTRACT

A multilayer ceramic electronic component includes an element body in which internal electrodes and dielectric layers are alternately stacked in a first direction, an element body having a pair of end surfaces, an upper surface and a lower surface, and a pair of side surfaces, a pair of side dielectric layers that cover the side surfaces, respectively, at least one of the side dielectric layers covering a first portion and not covering a second portion, the first portion being an end in a second direction of at least one of the upper surface and the lower surface and adjacent to a corresponding side surface, the second portion being a central portion in the second direction of the at least one of the upper surface and the lower surface and adjacent to the corresponding side surface, and a pair of external electrodes that cover the end surfaces, respectively.

### CROSS-REFERENCE TO RELATED APPLICATION

This application is based upon and claims the benefit of priority of the prior International Patent Application No. PCT/JP2024/013291, filed on Mar. 29, 2024, which claims the benefits of priorities of Japanese Patent Application No. 2023-058915 filed on Mar. 31, 2023, the entire contents of which are incorporated herein by reference.

### FIELD

A certain aspect of the present disclosure relates to a multilayer ceramic electronic component and a method of manufacturing the same.

### BACKGROUND

In a multilayer ceramic electronic component such as a multilayer ceramic capacitor, it is known that an element body in which internal electrodes are exposed from side surfaces is prepared, and dielectric sheets for side surface functioning as side margin portions are stuck to the side surfaces of the element body (for example, Japanese Laid-Open Patent Publication No. 2022-133459).

### SUMMARY OF THE INVENTION

According to a first aspect of the present disclosure, there is provided a multilayer ceramic electronic component including: an element body in which a plurality of internal electrodes and a plurality of dielectric layers are alternately stacked in a first direction, an element body having a pair of end surfaces on which the plurality of internal electrodes are alternately exposed, the pair of end surfaces facing each other in a second direction, an upper surface and a lower surface facing each other in the first direction, and a pair of side surfaces on which the plurality of internal electrodes are exposed, the pair of side surfaces facing each other; a pair of side dielectric layers that cover the pair of side surfaces, respectively, at least one of the side dielectric layers covering a first portion and not covering a second portion, the first portion being an end in the second direction of at least one surface of the upper surface and the lower surface and being adjacent to a corresponding side surface, the second portion being a central portion in the second direction of the at least one surface of the upper surface and the lower surface and being adjacent to the corresponding side surface; and a pair of external electrodes that cover the pair of end surfaces, respectively.

According to a second aspect of the present disclosure, there is provided a method of manufacturing a multilayer ceramic electronic component, including: preparing an element body in which a plurality of internal electrodes and a plurality of dielectric layers are alternately stacked in a first direction, an element body having a pair of end surfaces on which the plurality of internal electrodes are alternately exposed, the pair of end surfaces facing each other in a second direction, an upper surface and a lower surface facing each other in the first direction, and a pair of side surfaces on which the plurality of internal electrodes are exposed, the pair of side surfaces facing each other; sticking a pair of side dielectric layers to the pair of side surfaces; bending a part of at least one of the side dielectric layers so as to cover a first portion and not to cover a second portion, the first portion being an end in the second direction of at least one surface of the upper surface and the lower surface and being adjacent to a corresponding side surface, the second portion being a central portion in the second direction of the at least one surface of the upper surface and the lower surface and being adjacent to the corresponding side surface; and forming a pair of external electrodes that cover the pair of end surfaces, respectively.

### BRIEF DESCRIPTION OF THE DRAWINGS

FIG. 1 is a partial cross-sectional perspective view of a multilayer ceramic capacitor according to an embodiment.

FIG. 2 is a cross-sectional view taken along a line A-A of FIG. 1.

FIG. 3 is a cross-sectional view taken along a line B-B of FIG. 1.

FIG. 4 is a cross-sectional view taken along a line C-C of FIG. 1.

FIG. 5 is a cross-sectional view taken along a line D-D of FIG. 1.

FIG. 6 is a view of the multilayer ceramic capacitor according to the embodiment as seen from a Z direction through an external electrode.

FIG. 7 is a view of the multilayer ceramic capacitor according to the embodiment as seen from an X direction through the external electrode.

FIG. 8 is a cross-sectional view of a multilayer ceramic capacitor of a first comparative example, corresponding to a B-B cross section of FIG. 1.

FIG. 9 is a cross-sectional view of a multilayer ceramic capacitor of a second comparative example, corresponding to the B-B cross section of FIG. 1.

FIGS. 10A and 10B are diagrams illustrating states when the multilayer ceramic capacitors of the first and the second comparative examples are mounted on a mounting substrate, respectively.

FIG. 10C is a diagram illustrating a state when the multilayer ceramic capacitor of the embodiment is mounted on the mounting substrate.

FIG. 11 is a flowchart illustrating an example of steps of manufacturing the multilayer ceramic capacitor.

FIG. 12 is a plan view illustrating a method of manufacturing the multilayer ceramic capacitor.

FIGS. 13A to 13C are views corresponding to the cross section taken along a line A-A of FIG. 12.

FIGS. 14A and 14B are plan views illustrating a method of forming a bent portion.

FIGS. 15A to 15C are views corresponding to the cross section taken along a line A-A of FIGS. 14A and 14B.

FIG. 16A is a plan view illustrating a method of manufacturing the multilayer ceramic capacitor.

FIG. 16B is a cross-sectional view taken along a line A-A of FIG. 16A.

FIG. 17 is a cross-sectional view of another example of the multilayer ceramic capacitor according to the embodiment.

### DETAILED DESCRIPTION

By sticking the dielectric layers for side surface (hereinafter referred to as “side dielectric layers”) defining the side margin portions to the element body, the width of each of the side margin portions is reduced, and the size of the multilayer ceramic electronic component can be reduced. However, the side dielectric layers are likely to peel off from the element body.

The embodiments of the present disclosure provide a multilayer ceramic electronic component and a method of manufacturing a multilayer ceramic electronic component that can suppress peeling of the side dielectric layers.

Hereinafter, an embodiment will be described with reference to the drawings, using a multilayer ceramic capacitor as an example of a multilayer ceramic electronic component.

### Embodiment

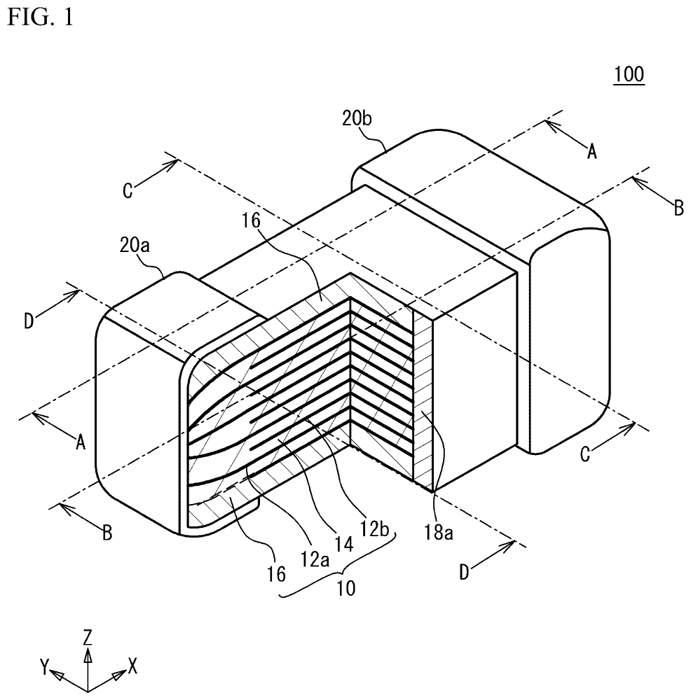

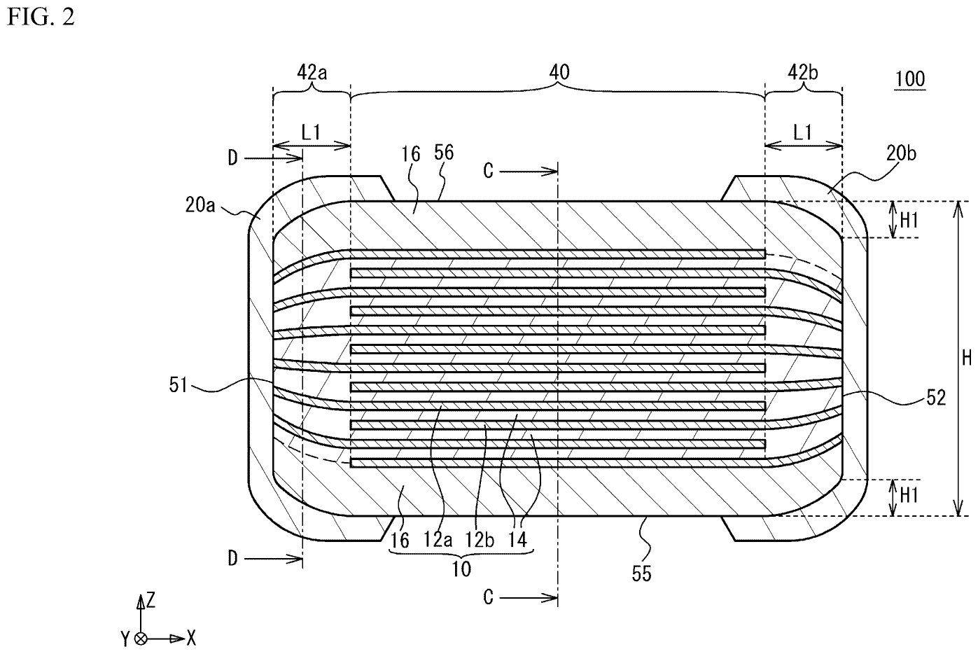

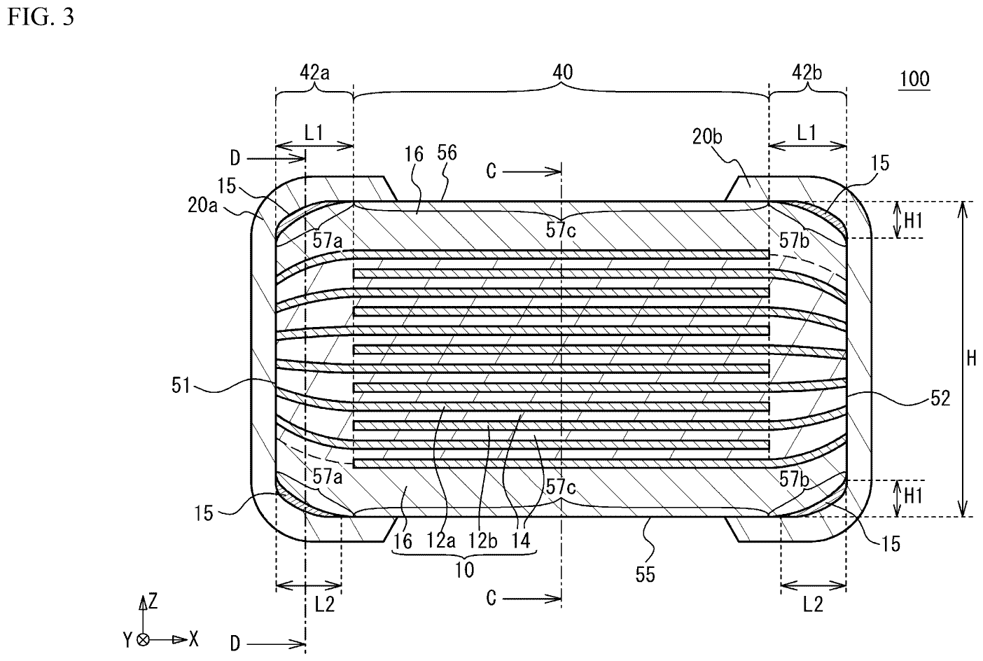

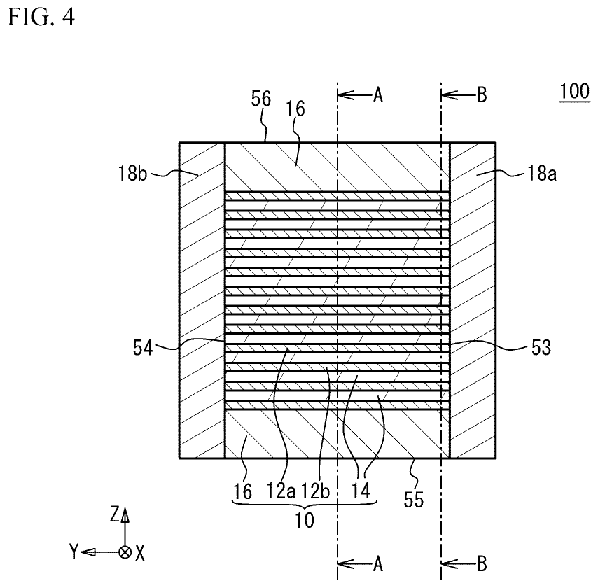

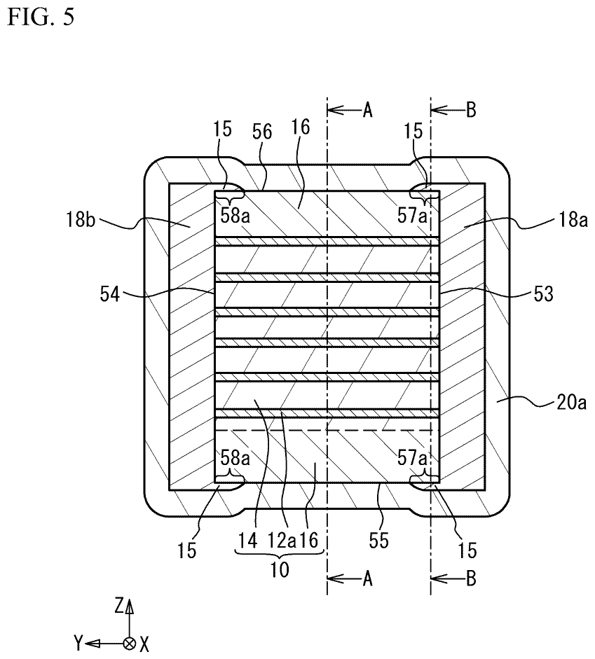

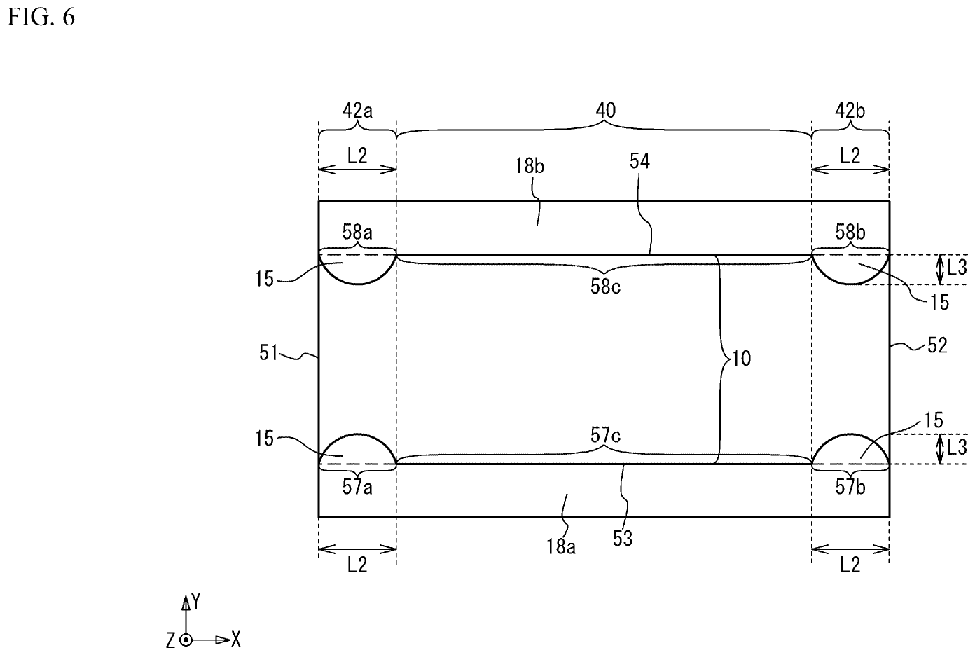

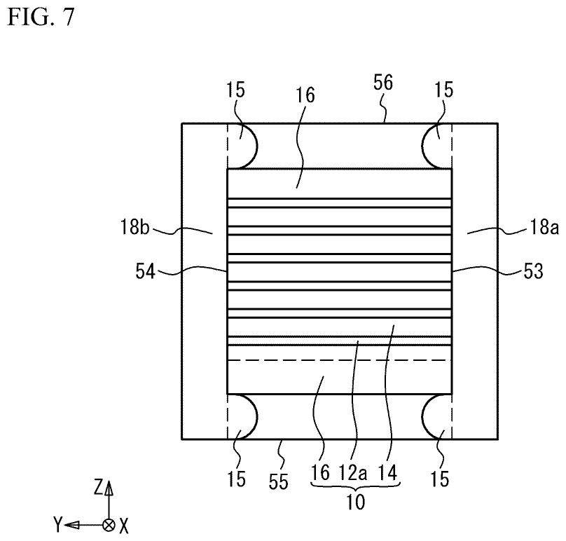

FIG. 1 is a partial cross-sectional perspective view of a multilayer ceramic capacitor according to an embodiment. FIG. 2 is a cross-sectional view taken along a line A-A in FIG. 1. FIG. 3 is a cross-sectional view taken along a line B-B in FIG. 1. FIG. 4 is a cross-sectional view taken along a line C-C in FIG. 1. FIG. 5 is a cross-sectional view taken along a line D-D in FIG. 1. FIG. 6 is a view of the multilayer ceramic capacitor according to the embodiment as viewed in a Z direction through the external electrode. FIG. 7 is a view of the multilayer ceramic capacitor according to the embodiment as viewed in an X direction through the external electrodes.

In FIGS. 1 to 7, the Z direction (first direction) is a stacking direction in which dielectric layers 14 and internal electrodes 12a and 12b are stacked, and is a direction in which a fifth surface 55 (lower surface) and a sixth surface 56 (upper surface) face each other. The X direction (second direction) is orthogonal to the Z direction, is a length direction of an element body 10, and is a direction in which a first surface 51 and a second surface 52 (a pair of end surfaces) of the element body 10 face each other. A Y direction (third direction) is orthogonal to the Z direction and the X direction, is a width direction of the internal electrodes 12a and 12b, and is a direction in which a third surface 53 and a fourth surface 54 (a pair of side surfaces) of the element body 10 face each other.

A multilayer ceramic capacitor 100 includes the element body 10 having a substantially rectangular parallelepiped shape, side dielectric layers 18a and 18b that form side margins, and external electrodes 20a and 20b.

The element body 10 includes a plurality of dielectric layers 14, a plurality of internal electrodes 12a and 12b, and cover dielectric layers 16. The plurality of internal electrodes 12a (first internal electrodes) and the plurality of internal electrodes 12b (second internal electrodes) are alternately stacked. One of the plurality of dielectric layers 14 is provided between one of the plurality of internal electrodes 12a and one of the plurality of internal electrodes 12b. The outermost layers in the stacking direction (Z direction) of a multilayer body in which the dielectric layers 14, the internal electrodes 12a and the internal electrodes 12b are stacked are the internal electrode 12a and the internal electrode 12b, and the upper surface and the lower surface of the multilayer body are covered with the cover dielectric layers 16.

The internal electrodes 12a and the internal electrodes 12b are alternately exposed on the first surface 51 and the second surface 52. The internal electrodes 12a are exposed from the first surface 51, and the internal electrodes 12b are not exposed. The internal electrodes 12b are exposed from the second surface 52, and the internal electrodes 12a are not exposed. That is, the internal electrodes 12a and the internal electrodes 12b are connected to the first surface 51 and the second surface 52, respectively.

As illustrated in FIGS. 2, 3, 5, and 6, a region of the element body 10, which is a central portion in the X direction and in which the internal electrodes 12a and 12b face each other, is a capacitance region 40. The regions located near the first surface 51 and the second surface 52 with respect to the capacitance region 40 are end margin regions 42a and 42b, respectively. In the end margin region 42a, the internal electrodes 12a are provided, and the internal electrodes 12b are not provided. In the end margin region 42b, the internal electrodes 12b are provided, and the internal electrodes 12a are not provided. Therefore, the height of the end margin regions 42a and 42b in the Z direction is smaller than the height of the capacitance region 40 in the Z direction. Therefore, in the end margin regions 42a and 42b, the ends of the fifth surface 55 are curved toward the sixth surface 56, and the ends of the sixth surface 56 is curved toward the fifth surface 55. In the capacitance region 40, the fifth surface 55 and the sixth surface 56 are each substantially planar.

The third surface 53 and the fourth surface 54 of the element body 10 are covered with the side dielectric layers 18a and 18b, respectively.

As illustrated in FIGS. 3, 5, and 6, bent portions 15 are provided at the ends of the fifth surface 55 and the sixth surface 56 in the X direction and at portions adjacent to the third surface 53 and the fourth surface 54. The bent portions 15 are portions where the side dielectric layers 18a and 18b are bent to the fifth surface 55 and the sixth surface 56. The portions of the fifth surface 55 and the sixth surface 56 covered by the bent portions 15 of the side dielectric layer 18a are portions 57a and 57b. The bent portions 15 of the side dielectric layer 18a do not cover a portion 57c which is adjacent to the third surface 53 and is the central portion of the fifth surface 55 and the sixth surface 56 in the X direction. The portions of the fifth surface 55 and the sixth surface 56 covered by the bent portions 15 of the side dielectric layer 18b are portions 58a and 58b. The bent portions 15 of the side dielectric layer 18b do not cover a portion 58c which is adjacent to the fourth surface 54 and is the central portion of the fifth surface 55 and the sixth surface 56 in the X direction.

Therefore, in FIG. 3, the outer surfaces of the external electrodes 20a and 20b in the end margin regions 42a and 42b are not as rounded as the outer surfaces of the element body 10. That is, the outer surfaces of the external electrodes 20a and 20b in the end margin regions 42a and 42b are closer to flat surfaces than the outer surfaces of the element body 10.

The external electrode 20a is in contact with the internal electrodes 12a at the first surface 51. The external electrode 20b is in contact with the internal electrodes 12b at the second surface 52.

The size of the multilayer ceramic capacitor 100 is, for example, 0.25 mm length (length in the X direction), 0.125 mm width (width in the Y direction), and 0.125 mm height (height in the Z direction), or 0.4 mm length, 0.2 mm width, and 0.2 mm height, or 0.6 mm length, 0.3 mm width, and 0.3 mm height, or 1.0 mm length, 0.5 mm width, and 0.5 mm height, or 3.2 mm length, 1.6 mm width, and 1.6 mm height, or 4.5 mm length, 3.2 mm width, and 2.5 mm height, but is not limited to these sizes.

The thickness of the side dielectric layers 18a and 18b is, for example, 10 μm to 30 μm. Lengths L1 in the X direction of the end margin regions 42a and 42b are, for example, 10 μm to 50 μm. The lengths L2 of the portions 57a, 57b, 58a, and 58b (that is, the lengths of the bent portions 15 in the X direction) is, for example, 10 μm to 50 μm. The lengths L1 and L2 may be the same as or different from each other. Lengths L3 of the bent portions 15 in the Y direction are, for example, 5 μm to 50 μm. The length between the first surface 51 and the second surface 52 in the X direction is, for example, 0.15 mm to 3 mm.

The internal electrodes 12a and 12b are composed of a base metal such as nickel (Ni), copper (Cu), or tin (Sn) as a main component. As the internal electrodes 12a and 12b, noble metals such as platinum (Pt), palladium (Pd), silver (Ag), and gold (Au), or alloys containing these metals may be used. The thickness of each of the internal electrodes 12a and 12b is, for example, 0.1 μm or more and 1 μm or less.

The dielectric layer 14 includes, for example, a ceramic material having a perovskite structure represented by the general formula ABO₃ as a main phase. The perovskite structure includes ABO_{3-α} that deviates from the stoichiometric composition. For example, as the ceramic material, at least one of barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming the perovskite structure can be selected and used. Ba_{1-x-y}CaₓSr_{y}Ti_{1-z}Zr₂O₃ is barium strontium titanate, barium calcium titanate, barium zirconate, barium zirconate titanate, calcium zirconate titanate, barium calcium zirconate titanate, or the like. For example, the main component ceramic is contained in the dielectric layer 14 in an amount of 90 at % or more. The thickness of the dielectric layer 14 is, for example, 2 μm or more and 5 μm or less.

An additive may be added to the dielectric layer 14. Examples of the additive to the dielectric layer 14 include zirconium (Zr), hafnium (Hf), magnesium (Mg), manganese (Mn), molybdenum (Mo), vanadium (V), chromium (Cr), and oxides of rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)), oxides containing cobalt (Co), nickel (Ni), lithium (Li), boron (B), sodium (Na), potassium (K), or silicon (Si), and glasses containing cobalt, nickel, lithium, boron, sodium, potassium, or silicon.

The composition of the main component ceramic of the cover dielectric layer 16 and the side dielectric layers 18a and 18b may be the same as or different from the main component ceramic of the dielectric layer 14.

The external electrodes 20a and 20b are composed of metals such as copper, nickel, aluminum (Al), and Zn (Zn), or alloys of two or more of these metals (for example, alloys of copper and nickel) as main components, and contain ceramics such as glass components for densifying the external electrodes 20a and 20b, and co-materials for controlling sinterability of the external electrodes 20a and 20b. The glass component is an oxide of barium (Ba), strontium (Sr), calcium (Ca), zinc, aluminum, silicon, boron, or the like. The co-material is, for example, a ceramic component containing the same material as the main component of the dielectric layer 14 as a main component. A plating film containing a base metal such as nickel, copper, or tin as a main component may be formed on the surfaces of the external electrodes 20a and 20b. Further, a film of a conductive resin such as an epoxy resin or a urethane resin may be formed on the surface of the plating film.

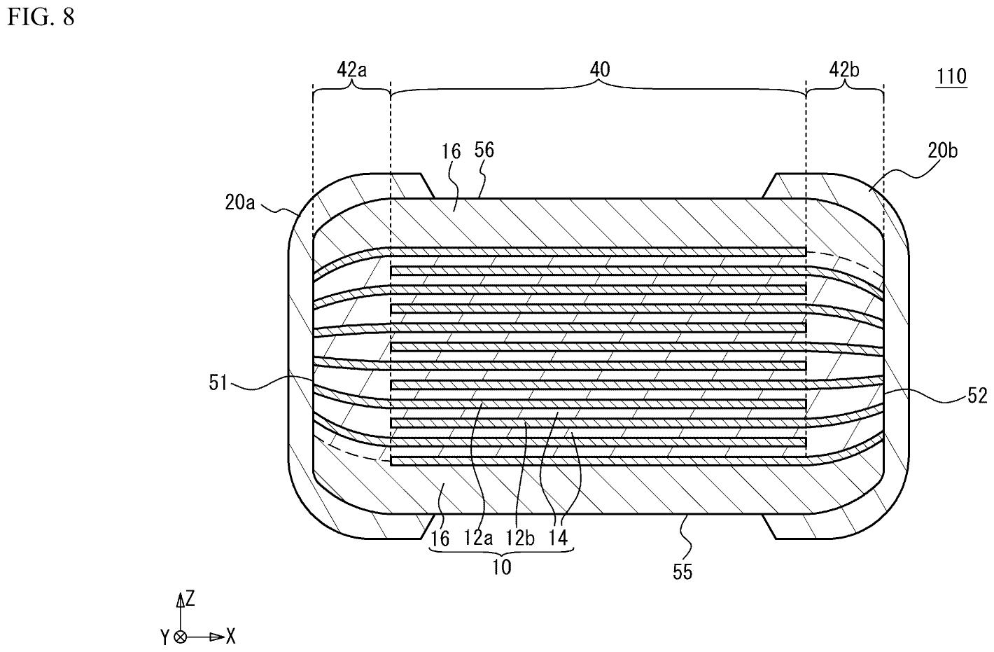

FIG. 8 is a cross-sectional view of the multilayer ceramic capacitor of a first comparative example, corresponding to a B-B cross section of FIG. 1. As illustrated in FIG. 8, in a multilayer ceramic capacitor 110 of the first comparative example, the side dielectric layers 18a and 18b are not bent to the fifth surface 55 and the sixth surface 56. Therefore, the side dielectric layers 18a and 18b are likely to be peeled off from the element body 10. In particular, when the cover dielectric layer 16 is thin, the side dielectric layer 18a and the side 18b are more likely to peel off. The outer surfaces of the external electrodes 20a and 20b in the end margin regions 42a and 42b are rounded to the same degree as the outer surfaces of the element body 10.

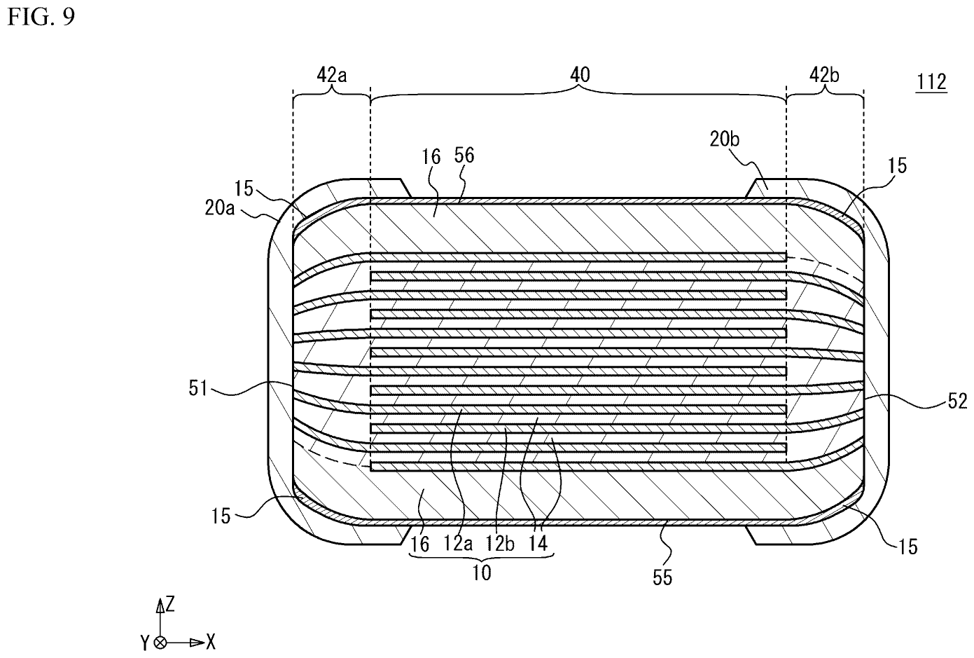

FIG. 9 is a cross-sectional view of the multilayer ceramic capacitor of a second comparative example, corresponding to the B-B cross section of FIG. 1. As illustrated in FIG. 9, in a multilayer ceramic capacitor 112 of a second comparative example, the side dielectric layers 18a and 18b are bent to the fifth surface 55 and the sixth surface 56 in the capacitance region 40 and the end margin regions 42a and 42b. This can suppress the side dielectric layers 18a and 18b from peeling off from the element body 10 as in the multilayer ceramic capacitor 110 in FIG. 8. However, the bent portion 15 is provided in the capacitance region 40, and thus the multilayer ceramic capacitor is increased in size.

In the multilayer ceramic capacitor 100 of the present embodiment, the bent portions 15 are provided in the portions 57a, 57b, 58a, 58b of the ends where the side dielectric layers 18a and 18b are likely to peel off, and the bent portions 15 are not provided in the capacitance region 40. This makes it possible to suppress the side dielectric layers 18a and 18b from peeling off from the element body 10 and to suppress the capacitance region 40 from increasing in size.

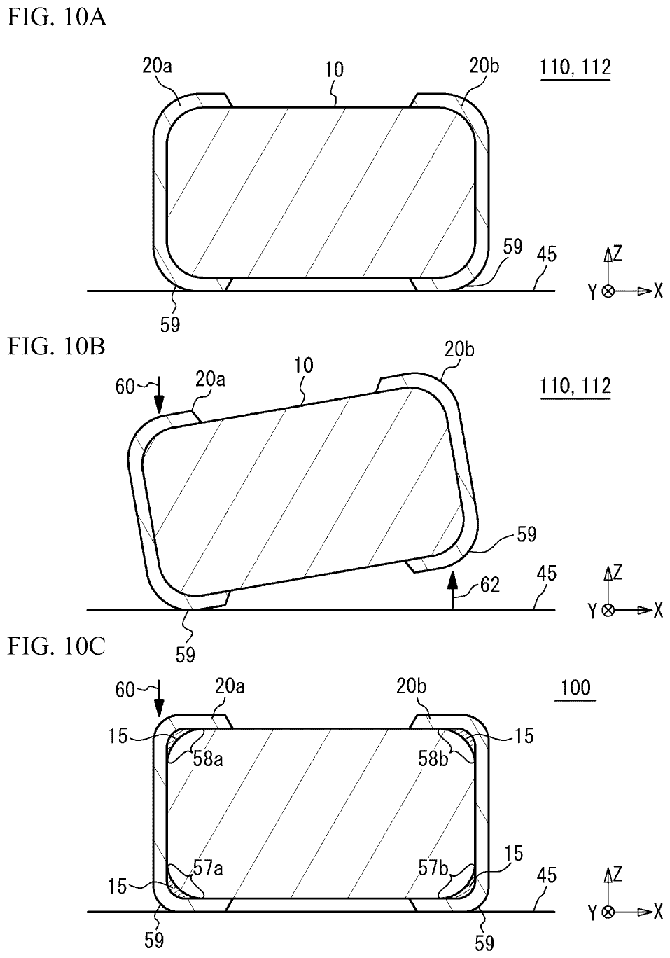

FIG. 10A and FIG. 10B are diagrams illustrating states when the multilayer ceramic capacitors of the first and the second comparative examples are mounted on a mounting substrate, and FIG. 10C is a diagram a state when the multilayer ceramic capacitor of the embodiment is mounted on the mounting board. As illustrated in FIG. 10A, the multilayer ceramic capacitor 110 or 112 of the first and the second comparative examples are disposed on a mounting substrate 45. In the multilayer ceramic capacitor 110 or 112, corner portions 59 of the external electrodes 20a and 20b as the ends are rounded.

As illustrated in FIG. 10B, in the multilayer ceramic capacitors 110 or 112 of the first and the second comparative examples, the corner portions 59 are rounded. Therefore, when a force 60 is applied downward (−Z direction) to the end of the multilayer ceramic capacitor 110 or 112 in the X direction, the opposite end is risen upward (+Z direction) as indicated by an arrow 62.

As illustrated in FIG. 10C, in the multilayer ceramic capacitor 100, the bent portions 15 are provided only in the portions 57a, 57b, 58a, and 58b as the ends in the X direction. Therefore, the corner portions 59 of the multilayer ceramic capacitor 100 are flatter than those of the multilayer ceramic capacitors 110 and 112, and the shape of the multilayer ceramic capacitor 100 can be made closer to a rectangle. Therefore, even when the force 60 is applied from above to the end of the multilayer ceramic capacitor 100 in the X direction, the opposite end can be suppressed from rising upward.

### (Method for Manufacturing Multilayer Ceramic Capacitor)

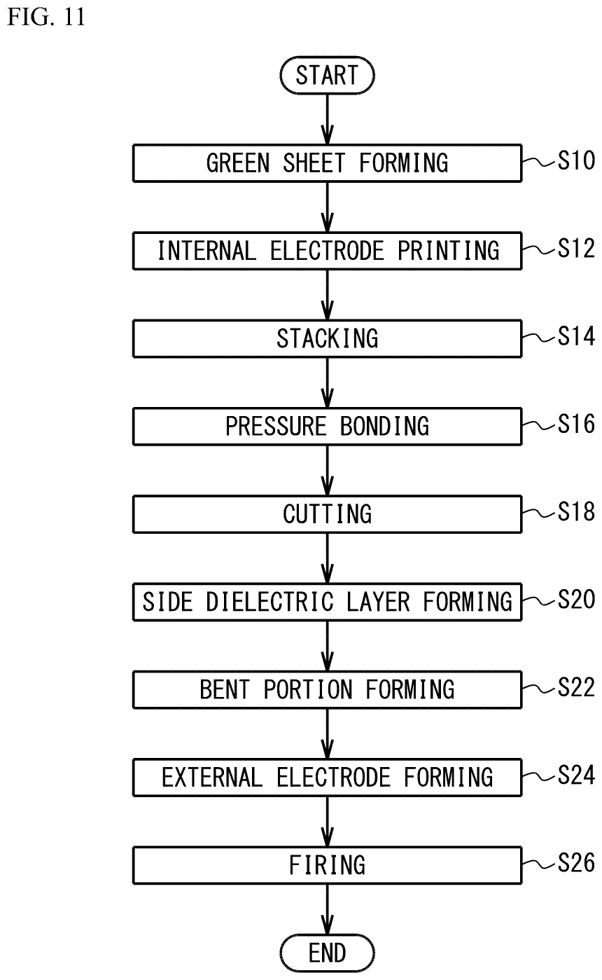

A method for manufacturing the multilayer ceramic capacitor 100 will be described. FIG. 11 is a flowchart illustrating an example of steps of manufacturing the multilayer ceramic capacitor.

### (Green Sheet Forming Step)

First, a green sheet is formed (step S10). In step S10, for example, a binder such as polyvinyl butyral (PVB), organic solvents such as ethanol or toluene, and a plasticizer are added to a dielectric material obtained by adding various additive compounds (such as a sinter aid) to ceramic powder, and the mixture is wet-mixed. For example, the obtained slurry is applied onto a supporting film by using a die coater method or a doctor blade method, and dried to form the green sheet. The supporting film is, for example, a PET (polyethylene terephthalate) film.

### (Internal Electrode Printing Step)

Subsequently, the internal electrodes are printed on the green sheets (step S12). In step S12, a metallic conductive paste for forming internal electrodes containing an organic binder is printed on the green sheet on the supporting film by using, for example, a gravure printing method. Thus, a plurality of internal electrode patterns corresponding to the internal electrodes 12a and 12b are formed on the green sheets so as to be spaced apart from each other. Ceramic particles are added to the metal conductive paste as a co-material. The main component of the ceramic particles is not particularly limited, but is preferably the same as the main component ceramic of the dielectric layer 14.

### (Stacking Step)

Subsequently, green sheets are stacked (step S14). In step S14, a multilayer sheet is formed by stacking green sheets on which patterns of internal electrodes to be the internal electrodes 12a and 12b are printed. Green sheets corresponding to the cover dielectric layers 16 are stacked on both end surfaces of the multilayer sheet in the stacking direction.

### (Pressure Bonding Step)

Subsequently, the multilayer sheet is pressure-bonded (step S16). In step S16, the plurality of green sheets are pressure-bonded by pressurizing the multilayer sheet formed in step S14. As a pressure bonding means, for example, an isostatic press is used.

### (Cutting Step)

Subsequently, the multilayer sheet is cut (step S18). In step S18, the multilayer sheet is cut along predetermined cut lines in the stacking direction by a cutter blade, so that a plurality of element bodies 10 are prepared. In the element body 10, as illustrated in FIGS. 6 and 7, the internal electrodes 12a are exposed from the first surface 51, the internal electrodes 12b are exposed from the second surface 52, and the internal electrodes 12a and 12b are exposed from the third surface 53 and the fourth surface 54.

### (Side Dielectric Layer Forming Step)

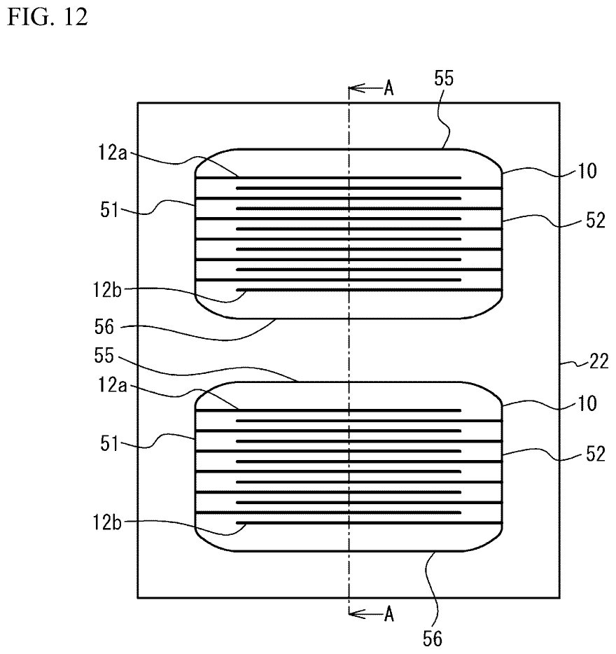

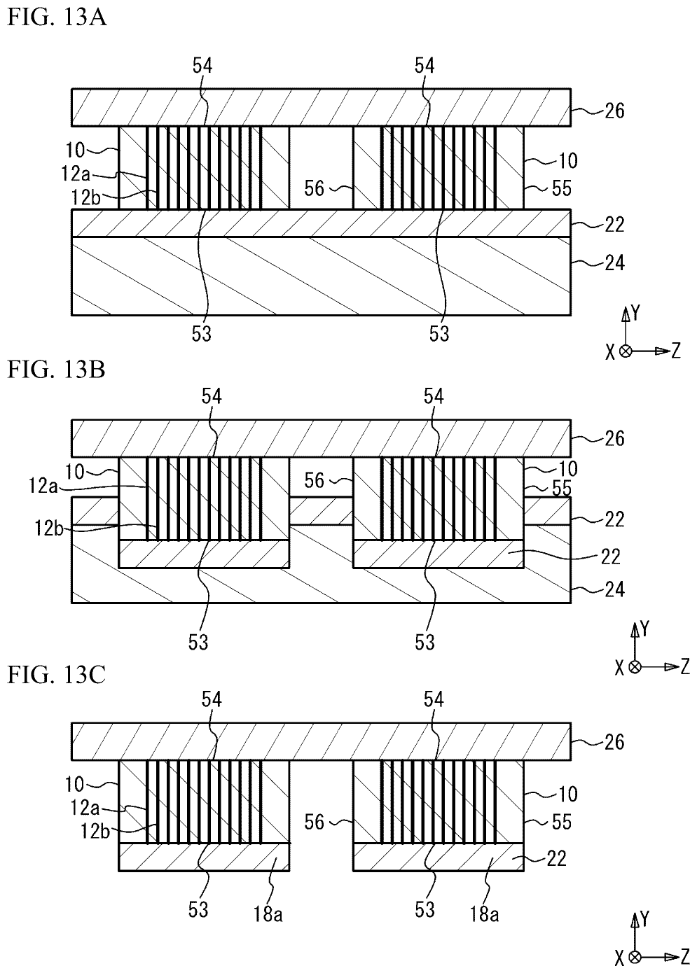

Subsequently, the side dielectric layers 18a and 18b are formed (step S20). Step S20 will be described below with reference to FIGS. 12 to 13C.

FIG. 12 is a plan view illustrating a method of manufacturing the multilayer ceramic capacitor. FIG. 13A to FIG. 13C are views corresponding to the cross section taken along a line A-A of FIG. 12. In FIG. 12, a tape 26 is not illustrated. As illustrated in FIGS. 12 and 13A, a dielectric green sheet 22 is disposed on a flat plate-shaped elastic body 24. The dielectric green sheet 22 is larger than the element body 10. The dielectric green sheet 22 is disposed so as to cover the third surface 53. The tape 26 is attached onto the fourth surface 54 of the element body 10.

Subsequently, as illustrated in FIG. 13B, the tape 26 is pressed downward (in the −Y direction) by a pressing device (not illustrated). As a result, the third surface 53 of the element body 10 is pressed against the surface of the dielectric green sheet 22. At this time, the pressed portion of the dielectric green sheet 22 is recessed by the pressing from the element body 10, and the elastic body 24 below the element body 10 is also recessed. The recessed portion of the dielectric green sheet 22 is pressed against the third surface 53 of the element body 10 by a restoring force from the elastic body 24. As a result, a part of the dielectric green sheet 22 is stuck to the third surface 53. At this time, the dielectric green sheet 22 is stuck along the corners of the element body 10 at both ends of the third surface 53 in the stacking direction (Z direction). Thereafter, when the pressing force of the element body 10 increases, a shearing force is generated between a stuck portion and the other portion of the dielectric green sheet 22, and thus the stuck portion and the other portion are separated from each other.

Subsequently, as illustrated in FIG. 13C, the tape 26 is moved upward (in the +Y direction) by the pressing device (not illustrated). As a result, the element body 10 moves away from the elastic body 24. At this time, the cut-off portion of the dielectric green sheet 22 is stuck to the third surface 53 of the element body 10, and is formed as the side dielectric layer 18a. Subsequently, as in FIGS. 12 to 13C, the side dielectric layer 18b is stuck to the fourth surface 54 of the element body 10.

### (Bent Portion Forming Step)

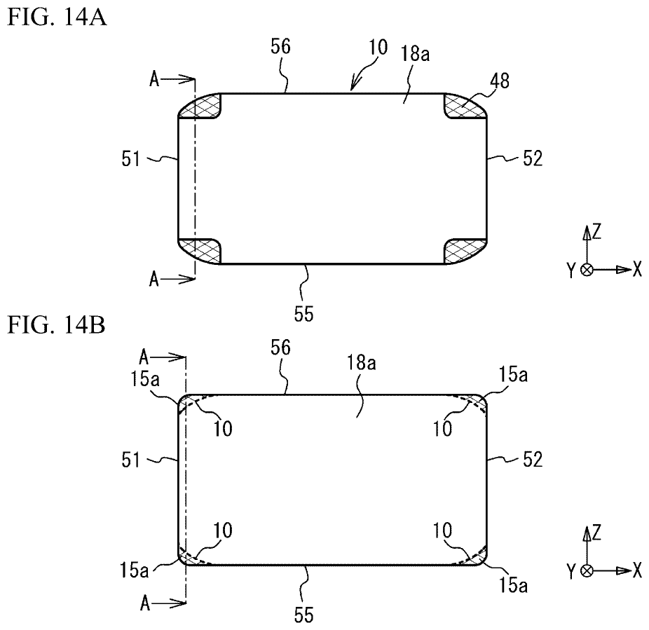

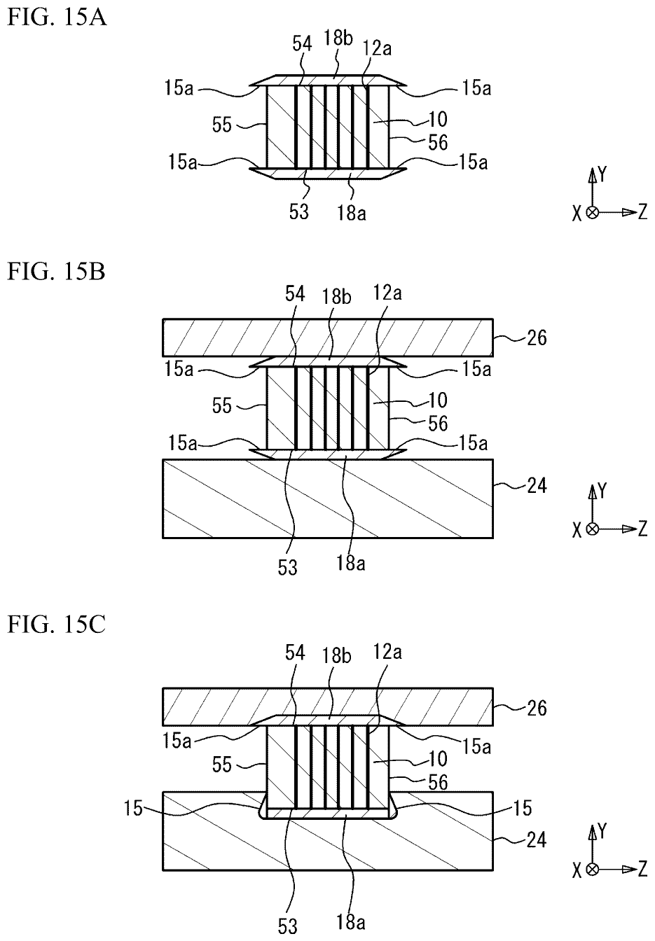

Subsequently, the bent portions 15 of the side dielectric layer 18a and 18b are formed (step S22). Step S22 will be described below with reference to FIGS. 14A to 15C.

FIGS. 14A and 14B are plan views illustrating a method of forming the bent portion. FIG. 15A to FIG. 15C are views corresponding to the cross section taken along the line A-A in FIG. 14A and FIG. 14B.

As illustrated in FIG. 14A, the side dielectric layer 18a is stuck to the third surface 53. The side dielectric layer 18a in regions 48 in the vicinity of the corner portions of the element body 10 is pushed and spread. As illustrated in FIG. 14B, the side dielectric layer 18a spreads in the vicinity of the corner portions, and protruding portions 15a protruding from the element body 10 are formed. As in FIG. 14A and FIG. 14B, the protruding portions 15a are formed also in the side dielectric layer 18b provided on the fourth surface 54.

As illustrated in FIG. 15A, the protruding portions 15a are provided to protrude outward from the element body 10. The thickness of the protruding portion 15a is smaller than the thickness of the central portion of the side dielectric layers 18a and 18b. Subsequently, as illustrated in FIG. 15B, the side dielectric layer 18a stuck to the third surface 53 is disposed on the flat plate-shaped elastic body 24. The tape 26 is stuck to the side dielectric layer 18b stuck to the fourth surface 54 of the element body 10.

As illustrated in FIG. 15C, the tape 26 is pressed downward (in the −Y direction) by the pressing device (not illustrated). As a result, the protruding portions 15a of the side dielectric layer 18a are bent to the fifth surface 55 and the sixth surface 56 of the element body 10, and becomes the bent portions 15 stuck to the fifth surface 55 and the sixth surface 56. As in FIGS. 15A to 15C, the protruding portions 15a of the side dielectric layer 18b provided on the fourth surface 54 are bent to the fifth surface 55 and the sixth surface 56. As a result, the bent portions 15 are formed.

### (External Electrode Forming Step)

Referring back to FIG. 11, subsequently, the external electrodes 20a and 20b are formed (step S24). In step S24, a conductive paste containing, for example, metal powder, glass frits, binders, and solvents is applied to the first surface 51 and the second surface 52 of the element body 10 to which the side dielectric layers 18a and 18b are suck. After applying the conductive paste, the paste is baked to form the base metal layer on the external electrodes 20a and 20b. The binder and the solvent are evaporated by baking. The conductive paste is applied by, for example, a dipping method.

### (Firing Step)

Subsequently, the element body 10, the side dielectric layers 18a and 18b, the external electrodes 20a and 20b are fired (step S26). In step S26, the element body 10 on which the side dielectric layers 18a and 18b, and the external electrodes 20a and 20b are formed is subjected to a debinding treatment in a nitrogen atmosphere at 250° C. to 500° C., and then fired in a reduction atmosphere at 1300° C. to 1400° C. for about 1 hour. As a result, each particle in the element body 10 and the side dielectric layers 18a and 18b is sintered. After step S26, plating metal layers may be formed on the surfaces of the base metal layers of the external electrodes 20a and 20b by using a plating method.

### (Another Example of Bent Portion Forming Step)

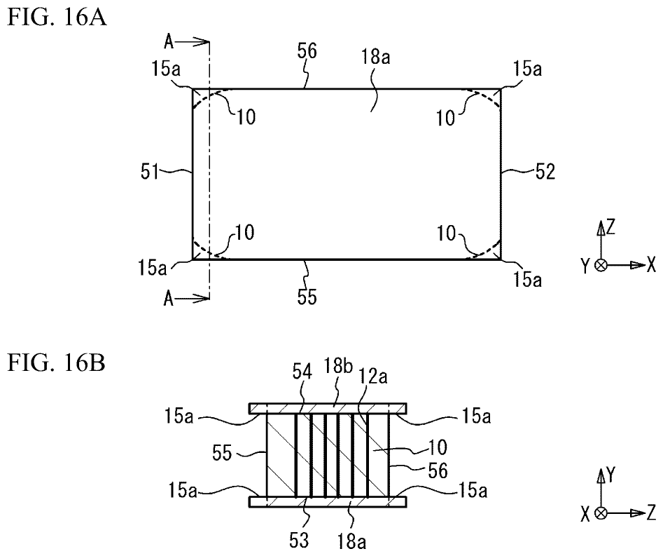

FIG. 16A is a plan view illustrating a method for manufacturing the multilayer ceramic capacitor, and FIG. 16B is a cross-sectional view taken along a line A-A of FIG. 16A. As illustrated in FIGS. 16A and 16B, when the dielectric green sheet 22 stuck to the element body 10 is cut, the dielectric green sheet 22 is cut larger than the element body 10 at the corner portions of the element body 10 to form the side dielectric layers 18a and 18b. In the example of FIG. 16A, the side dielectric layers 18a and 18b are rectangular. The side dielectric layers 18a and 18b on the outer side of the corner portions of the element body 10 are the protruding portions 15a. As in FIGS. 15A to 15C, the bent portions 15 can be formed by bending the protruding portions 15a toward the fifth surface 55 and the sixth surface 56 of the element body 10. The bent portions 15 may be formed by a method other than the method described with reference to FIGS. 14A to 16B.

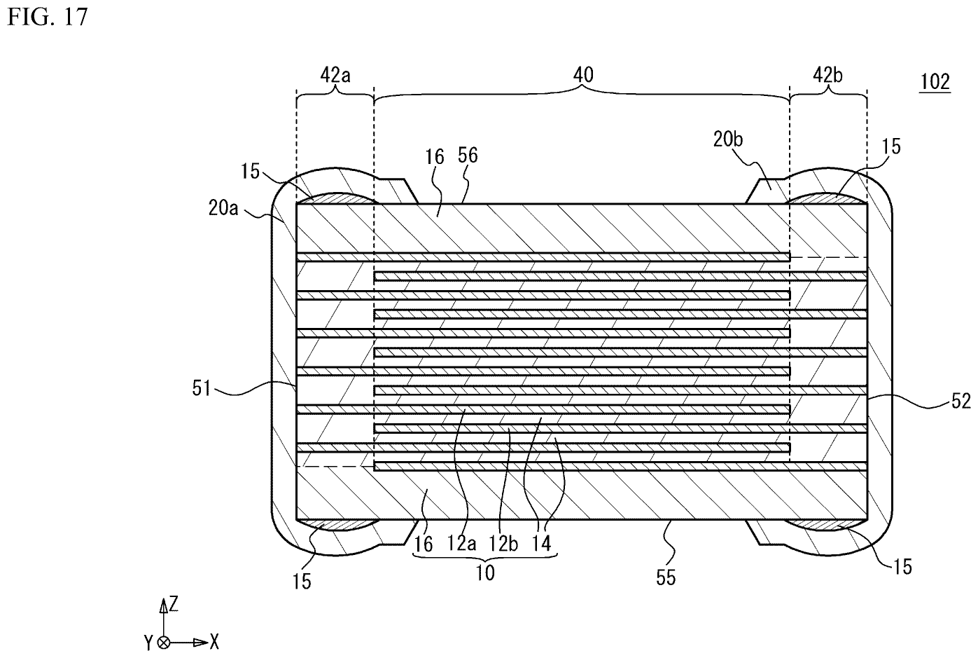

FIG. 17 is a cross-sectional view of another example of the multilayer ceramic capacitor according to the embodiment, and corresponds to the cross-section taken along a line B-B in FIG. 1. As illustrated in FIG. 17, in a multilayer ceramic capacitor 102, the fifth surface 55 and the sixth surface 56 in the end margin regions 42a and 42b of the element body 10 are substantially flat surfaces. For example, a dielectric layer having a thickness corresponding to the thicknesses of the plurality of internal electrodes 12b is added to the end margin region 42a, and a dielectric layer having a thickness corresponding to the thicknesses of the plurality of internal electrodes 12a is added to the end margin region 42b. The corner portions of the external electrodes 20a and 20b are expanded by the bent portions 15.

Since the multilayer ceramic capacitor 102 of FIG. 17 includes the bent portions 15, the peeling of the side dielectric layers 18a and 18b can be suppressed as compared with the multilayer ceramic capacitor 110 of the first comparative example of FIG. 8. Since the multilayer ceramic capacitor 102 of FIG. 17 does not include the bent portion 15 in the capacitance region 40, the multilayer ceramic capacitor 112 of FIG. 17 can be reduced in size as compared with the multilayer ceramic capacitor 112 of the second comparative example of FIG. 9.

In the embodiment, as illustrated in FIG. 3 and FIG. 5 to FIG. 7, both the side dielectric layers 18a and 18b cover the third surface 53 and the fourth surface 54, respectively, cover the portions 57a, 57b, 58a, and 58b (first portions) which are ends in the X direction of the fifth surface 55 and the sixth surface 56 and are adjacent to the third surface 53 and the fourth surface 54, and do not cover the portions 57c and 58c (second portion) which are the central portions in the X direction of the fifth surface 55 and the sixth surface 56 and are adjacent to the third surface 53 and the fourth surface 54. Accordingly, as compared with the multilayer ceramic capacitor 110 of the first comparative example illustrated in FIG. 8, the side dielectric layer 18a is suppressed from being peeled off from the element body 10. In addition, it is possible to reduce in size as compared with the multilayer ceramic capacitor 110 of the second comparative example illustrated in FIG. 9.

As illustrated in FIGS. 2 and 3, the fifth surface 55 and the sixth surface 56 in the end margin regions 42a and 42b are curved so as to approach the other of the fifth surface 55 and the sixth surface 56 toward the ends of the fifth surface 55 and the sixth surface 56, respectively. In this case, as illustrated in FIG. 10B, the corner portions 59 of the external electrodes 20a and 20b are rounded, and thus the ends of the multilayer ceramic capacitor are likely to rise. Therefore, as illustrated in FIG. 10C, it is preferable to provide the bent portions 15 in the end margin regions.

The curvature of the fifth surface 55 and the sixth surface 56 in the end margin region 42a (and 42b) is caused because the internal electrodes 12b (and 12a) are not provided in the end margin region 42a (and 42b) and the thickness of the element body 10 is smaller than that in the capacitance region 40. Therefore, the fifth surface 55 and the sixth surface 56 in the capacitance region 40 are substantially flat surfaces. As illustrated in FIGS. 2 and 3, the size H1 of the curvature of the fifth surface 55 is defined as a difference between a position of the fifth surface 55 in the Z direction in the capacitance region 40 and a position in the Z direction where the fifth surface 55 is in contact with the first surface 51 (and the second surface), and the size H1 of the curvature of the sixth surface 56 is also defined as the same. In this case, the size H1 of the curvature of the fifth surface 55 and the sixth surface 56 is, for example, 0.03 times or more and 0.15 times or less the height H of the element body 10 in the Z direction. In this case, as illustrated in FIG. 10B, the corner portions 59 of the external electrodes 20a and 20b are rounded, and thus the end portions of the multilayer ceramic capacitor is likely to rise. Therefore, as illustrated in FIG. 10C, it is preferable to provide the bent portions 15 in the end margin regions.

In this way, when the fifth surface 55 and the sixth surface 56 are curved in the end margin regions 42a and 42b, the portions 57c and 58c where the bent portions 15 are not provided are provided in the capacitance region 40, and the portions 57a, 57b, 58a and 58b where the bent portions 15 are provided are provided in at least parts of the end margin regions 42a and 42b. This allows the corner portions of the external electrodes 20a and 20b to be flatter as illustrated in FIG. 3. In addition, since the bent portions 15 are provided in the end margin regions 42a and 42b where the element body 10 is curved, the multilayer ceramic capacitor can be reduced in size.

As illustrated in FIGS. 3 and 6, when the length of the end margin regions 42a and 42b in the X direction is denoted by L1 and the maximum length of the bent portion 15 in the X direction is denoted by L2, the length L2 is preferably equal to or greater than 1/10 of the length L1, more preferably equal to or greater than ⅕ of the length L1, and further preferably equal to or greater than ½ of the length L1, from the viewpoint of suppressing peeling of the side dielectric layers 18a and 18b. From the viewpoint of not providing the bent portion 15 in the capacitance region 40, the length L2 is preferably equal to or less than the length L1, and more preferably equal to or less than 9/10 of the length L1. When the maximum length of the bent portion 15 in the Y direction is defined as L3, the length L3 is preferably equal to or greater than 1/10 of the length L2, more preferably equal to or greater than ⅕ of the length L2, and still more preferably equal to or greater than ½ of the length L2, from the viewpoint of suppressing peeling of the side dielectric layers 18a and 18b. From the viewpoint of ease of forming the bent portion 15, the length L3 is preferably equal to or less than the length L2, and more preferably equal to or greater than ½ of the length L2.

As illustrated in FIG. 14A to FIG. 15C, when the bent portions 15 are formed, the bent portions 15 in the portions 57a, 57b, 58a, and 58b are thinner than the side dielectric layers 18a and 18b in the capacitance region 40 of the third surface 53 and the fourth surface 54. This improves the adhesion of the side dielectric layers 18a and 18b by the bent portions 15, and enables a decrease in size. From the viewpoint of a decrease in size, the thickness of the bent portion 15 is preferably 9/10 or less, more preferably 8/10 or less of the thickness of the side dielectric layers 18a and 18b in the capacitance region 40.

An example has been described in which both of the pair of side dielectric layers 18a and 18b cover the portions 57a, 57b, 58a and 58b of both of the fifth surface 55 and the sixth surface 56, and do not cover either of the portions 57c and 58c of both of the fifth surface 55 and the sixth surface 56. It is sufficient that at least one of the side dielectric layers 18a and 18b covers the portions 57a, 57b, 58a and 58b of at least one of the fifth surface 55 and the sixth surface 56, and does not cover the portions 57c and 58c of the at least one of the fifth surface 55 and the sixth surface 56. For example, the side dielectric layer 18a may cover any one of the portions 57a and 57b, and may not cover the other. The side dielectric layer 18b may cover any one of the portions 58a and 58b and may not cover the other.

As illustrated in FIG. 10C, from the viewpoint of preventing the end portion from rising, the bent portions 15 are preferably provided in the portions 57a, 57b, 58a, and 58b of the fifth surface 55, and the bent portions 15 may not be provided in the sixth surface 56.

Although the embodiments of the present disclosure are described in detail above, the present disclosure is not limited to the specific embodiments. It is to be understood that the various change, substitutions, and alterations could be made hereto without departing from the spirit and scope of the invention.

What is claimed is:

1. A multilayer ceramic electronic component comprising:
an element body in which a plurality of internal electrodes and a plurality of dielectric layers are alternately stacked in a first direction, an element body having a pair of end surfaces on which the plurality of internal electrodes are alternately exposed, the pair of end surfaces facing each other in a second direction, an upper surface and a lower surface facing each other in the first direction, and a pair of side surfaces on which the plurality of internal electrodes are exposed, the pair of side surfaces facing each other;
a pair of side dielectric layers that cover the pair of side surfaces, respectively, at least one of the side dielectric layers covering a first portion and not covering a second portion, the first portion being an end in the second direction of at least one surface of the upper surface and the lower surface and being adjacent to a corresponding side surface, the second portion being a central portion in the second direction of the at least one surface of the upper surface and the lower surface and being adjacent to the corresponding side surface; and
a pair of external electrodes that cover the pair of end surfaces, respectively.

2. The multilayer ceramic electronic component according to claim 1,
wherein the at least one surface in a pair of end margin regions located closer to the pair of end surfaces than a capacitance region in which the plurality of internal electrodes face each other is curved so as to approach another surface of the upper surface and the lower surface toward the pair of end surfaces.

3. The multilayer ceramic electronic component according to claim 2,
wherein the second portion is provided in the capacitance region, and the first portion is provided in at least a part of the end margin regions.

4. The multilayer ceramic electronic component according to claim 3,
wherein a maximum length of the first portion in the second direction is equal to or more than about 1/10 of a length of each of the end margin regions in the second direction.

5. The multilayer ceramic electronic component according to claim 1,
wherein a thickness of the at least one side dielectric layer in the first portion is thinner than a thickness of the at least one side dielectric layer in a capacitance region in which the plurality of internal electrodes face each other.

6. The multilayer ceramic electronic component according to claim 1,
wherein both of the pair of side dielectric layers cover the first portion of both of the upper surface and the lower surface and do not cover the second portion of both of the upper surface and the lower surface.

7. The multilayer ceramic electronic component according to claim 6,
wherein the upper surface and the lower surface in a pair of end margin regions located closer to the pair of end surfaces than a capacitance region in which the plurality of internal electrodes face each other are curved so as to approach another surfaces of the upper surface and the lower surface toward the pair of end surfaces.

8. A method of manufacturing a multilayer ceramic electronic component, comprising:
preparing an element body in which a plurality of internal electrodes and a plurality of dielectric layers are alternately stacked in a first direction, an element body having a pair of end surfaces on which the plurality of internal electrodes are alternately exposed, the pair of end surfaces facing each other in a second direction, an upper surface and a lower surface facing each other in the first direction, and a pair of side surfaces on which the plurality of internal electrodes are exposed, the pair of side surfaces facing each other;
sticking a pair of side dielectric layers to the pair of side surfaces;
bending a part of at least one of the side dielectric layers so as to cover a first portion and not to cover a second portion, the first portion being an end in the second direction of at least one surface of the upper surface and the lower surface and being adjacent to a corresponding side surface, the second portion being a central portion in the second direction of the at least one surface of the upper surface and the lower surface and being adjacent to the corresponding side surface; and
forming a pair of external electrodes that cover the pair of end surfaces, respectively.
